(19) United States
(12) Patent Application Publication
(10) Pub. No.: US 2026/0349229 A1
(43) Pub. Date: Nov. 5, 2026

(54) VARIABLE MAGNIFICATION OPTICAL SYSTEM, OPTICAL DEVICE, AND METHOD FOR MANUFACTURING VARIABLE MAGNIFICATION OPTICAL SYSTEM

(71) Applicant: NIKON CORPORATION, Shinagawa-ku, Tokyo (JP)

(72) Inventors: Tomoyuki SASHIMA, Tokyo (JP); Kyoya TOKUNAGA, Yokohama-shi (JP)

(21) Appl. No.: 19/136,656

(22) PCT Filed: Dec. 7, 2023
(86) PCT No.: PCT/JP2023/043740

§ 371 Date: Dec. 9, 2025

(30) Foreign Application Priority Data
Dec. 9, 2022 (JP) 2022-197185

(51) Int. Cl. G02B 15/14

(52) U.S. Cl. CPC G02B 15/146

(57) ABSTRACT

A zoom optical system (ZL) comprises, in order from an object along an optical axis, a first lens group (G1) having positive refractive power, a second lens group (G2) having negative refractive power, a third lens group (G3) having positive refractive power, and a rear group (GR) including at least five lens groups, wherein when zooming, a distance between each adjacent lens group changes, and the first lens group (G1) is fixed relative to an image surface (I) and the following conditional expressions are satisfied.

0.05<(−f2)/f1<1.00

0.02<Bft/ft<0.15
Where f1: a focal length of the first lens group (G1),
f2: a focal length of the second lens group (G2),
ft: a focal length of the zoom optical system (ZL) in a telephoto end state, and
Bft: a back focus of the zoom optical system (ZL) in the telephoto end state.

### TECHNICAL FIELD

The present invention relates to a zoom optical system (or a zoom variable magnification optical system), an optical device, and a method of manufacturing the zoom optical system.

### TECHNICAL BACKGROUND

Conventionally, a zoom optical system suitable for a photographic camera, an electronic still camera, a video camera, and the like has been proposed (for example, see Patent Literature 1). In such a zoom optical system, it is difficult to obtain bright and favorable optical performance while being compact.

### PRIOR ARTS LIST

### Patent Document

Patent Document 1: Japanese Laid-Open Patent Publication No. 2020-52338 (A)

### SUMMARY OF THE INVENTION

A zoom optical system according to a first aspect of the present invention comprises, in order from an object along an optical axis, a first lens group having positive refractive power, a second lens group having negative refractive power, a third lens group having positive refractive power, and a rear group including at least five lens groups, wherein when zooming, a distance between each adjacent lens group changes, and the first lens group is fixed relative to an image surface and the following conditional expressions are satisfied.

0.05<(−f2)/f1<1.00

0.02<Bft/ft<0.15
Where f1: a focal length of the first lens group,
f2: a focal length of the second lens group,
ft: a focal length of the zoom optical system in a telephoto end state, and
Bft: a back focus of the zoom optical system in the telephoto end state.

A zoom optical system according to a second aspect of the present invention comprises, in order from an object along an optical axis, a first lens group having positive refractive power, a second lens group having negative refractive power, a third lens group having positive refractive power, and a rear group including at least five lens groups, wherein when zooming, a distance between each adjacent lens group changes, and the first lens group is fixed relative to an image surface and the at least five lens groups of the rear group include a first focus lens group having negative refractive power, and a second focus lens group having positive refractive power and being arranged closer to the image surface than the first focus lens group, when focusing, the first focus lens group and the second focus lens group move along the optical axis at different trajectories and the following conditional expressions are satisfied.

0.10<(−fF1)/fF2<1.30

0.01<Bfw/fw<0.50
Where fF1: a focal length of the first focus lens group,
fF2: a focal length of the second focus lens group,
fw: a focal length of the zoom optical system in a wide-angle end state, and
Bfw: a back focus of the zoom optical system in the wide-angle end state.

An optical device according to the present invention includes the above zoom optical system.

A method of manufacturing a zoom optical system according to a first aspect of the present invention comprises, in order from an object along an optical axis, a first lens group having positive refractive power, a second lens group having negative refractive power, a third lens group having positive refractive power, and a rear group including at least five lens groups, wherein when zooming, a distance between each adjacent lens group changes, and the first lens group is fixed relative to an image surface and the method of manufacturing the zoom optical system comprises arranging each lens in a lens barrel so as to satisfy the following conditional expressions.

0.05<(−f2)/f1<1.00

0.02<Bft/ft<0.15
Where f1: a focal length of the first lens group,
f2: a focal length of the second lens group,
ft: a focal length of the zoom optical system in a telephoto end state, and
Bft: a back focus of the zoom optical system in the telephoto end state.

A method of manufacturing a zoom optical system according to a second aspect of the present invention comprises, in order from an object along an optical axis, a first lens group having positive refractive power, a second lens group having negative refractive power, a third lens group having positive refractive power, and a rear group including at least five lens groups, wherein when zooming, a distance between each adjacent lens group changes, and the first lens group is fixed relative to an image surface and the at least five lens groups of the rear group include a first focus lens group having negative refractive power, and a second focus lens group having positive refractive power and being arranged closer to the image surface than the first focus lens group, when focusing, the first focus lens group and the second focus lens group move along the optical axis at different trajectories and the method of manufacturing the zoom optical system comprises arranging each lens in a lens barrel so as to satisfy the following conditional expressions.

0.10<(−fF1)/fF2<1.30

0.01<Bfw/fw<0.50
Where fF1: a focal length of the first focus lens group,
fF2: a focal length of the second focus lens group,
fw: a focal length of the zoom optical system in a wide-angle end state, and
Bfw: a back focus of the zoom optical system in the wide-angle end state.

### BRIEF DESCRIPTION OF THE DRAWINGS

FIG. 1 is a diagram showing a lens configuration of a zoom optical system according to a first example;

FIG. 2 illustrates graphs showing various aberrations upon focusing on infinity in a wide-angle end state of the zoom optical system according to the first example;

FIG. 3 illustrates graphs showing various aberrations upon focusing on infinity in a telephoto end state of the zoom optical system according to the first example;

FIG. 4 is a diagram showing a lens configuration of a zoom optical system according to a second example;

FIG. 5 illustrates graphs showing various aberrations upon focusing on infinity in a wide-angle end state of the zoom optical system according to the second example;

FIG. 6 illustrates graphs showing various aberrations upon focusing on infinity in a telephoto end state of the zoom optical system according to the second example;

FIG. 7 is a diagram showing a lens configuration of a zoom optical system according to a third example;

FIG. 8 illustrates graphs showing various aberrations upon focusing on infinity in a wide-angle end state of the zoom optical system according to the third example;

FIG. 9 illustrates graphs showing various aberrations upon focusing on infinity in a telephoto end state of the zoom optical system according to the third example;

FIG. 10 is a diagram showing a configuration of a camera including a zoom optical system according to each embodiment;

FIG. 11 is a flowchart showing a method of manufacturing the zoom optical system according to a first embodiment; and

FIG. 12 is a flowchart showing a method of manufacturing the zoom optical system according to a second embodiment.

### DESCRIPTION OF THE EMBODIMENTS

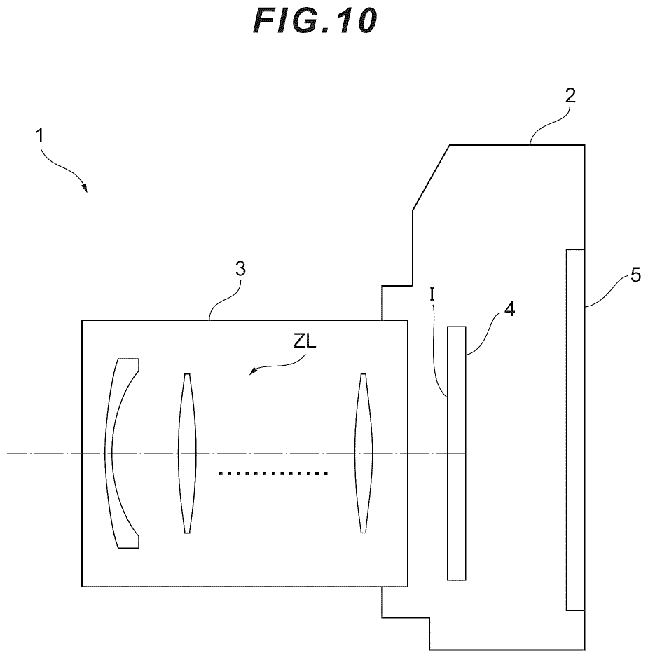

Hereinafter, preferred embodiments according to the present invention will be described. First, a camera (optical device) including a zoom optical system according to each embodiment will be described with reference to FIG. 10. As shown in FIG. 10, this camera 1 includes a main body 2 and a photographic lens 3 that is attached to the main body 2. The main body 2 includes an imaging element 4, a main body control part (not shown) that controls an operation of a digital camera, and a liquid crystal screen 5. The photographic lens 3 includes a zoom optical system ZL comprising a plurality of lens groups, and a lens position control mechanism (not shown) that controls a position of each lens group. The lens position control mechanism includes a sensor that detects a position of the lens groups, a motor for moving the lens groups forward and rearward along an optical axis, a control circuit that drives motor, and the like.

Light from a subject is collected by the zoom optical system ZL of the photographic lens 3 and reaches an image surface I of the imaging element 4. The light from the subject that has reached the image surface I is photoelectrically converted by the imaging element 4 and recorded as digital image data on a memory (not shown). The digital image data recorded on the memory can be displayed on the liquid crystal screen 5 in response to an operation by a user. Note that this camera can be a mirrorless camera or a single-lens reflex camera including a quick-return mirror. The zoom optical system ZL shown in FIG. 10 is a schematic representation of the zoom optical system included in the photographic lens 3, and a lens configuration of the zoom optical system ZL is not limited to this configuration.

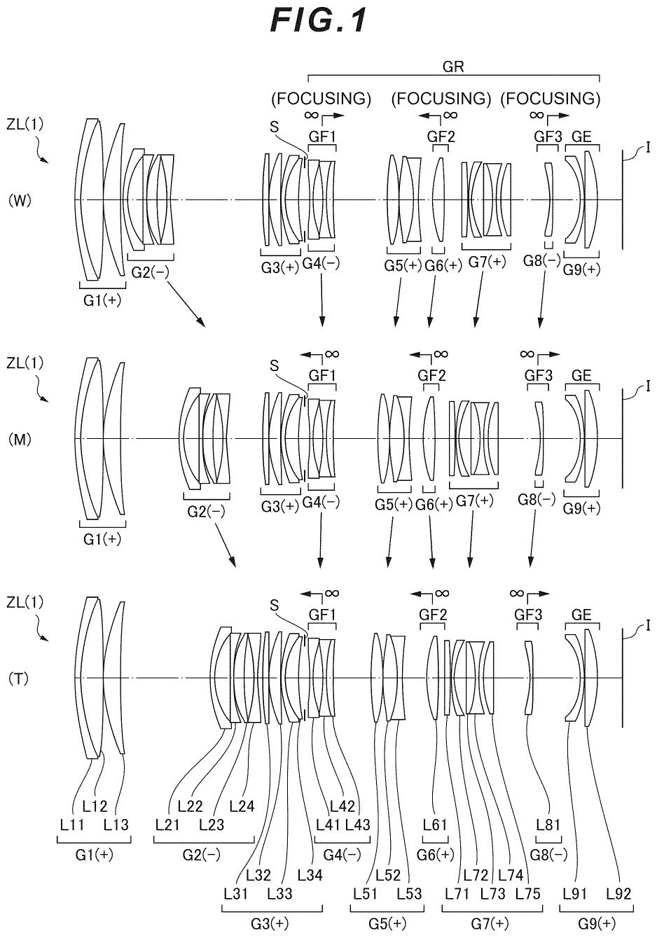

Next, the zoom optical system according to the first embodiment will be described. As shown in FIG. 1, the zoom optical system ZL(1) as an example of the zoom optical system (zoom lens) ZL according to the first embodiment comprises, in order from an object along an optical axis, a first lens group G1 having positive refractive power, a second lens group G2 having negative refractive power, a third lens group G3 having positive refractive power, and a rear group GR including at least five lens groups. When zooming, a distance between each adjacent lens group changes, and the first lens group G1 is fixed relative to the image surface I.

Based on the above configuration, the zoom optical system ZL according to the first embodiment satisfies the following conditional expression (1) and conditional expression (2).

0.05<(−f2)/f1<1.00 (1)

0.02<Bft/ft<0.15 (2)
Where f1: a focal length of the first lens group G1,
f2: a focal length of the second lens group G2,
ft: a focal length of the zoom optical system ZL in the telephoto end state, and
Bft: a back focus of the zoom optical system ZL in the telephoto end state.

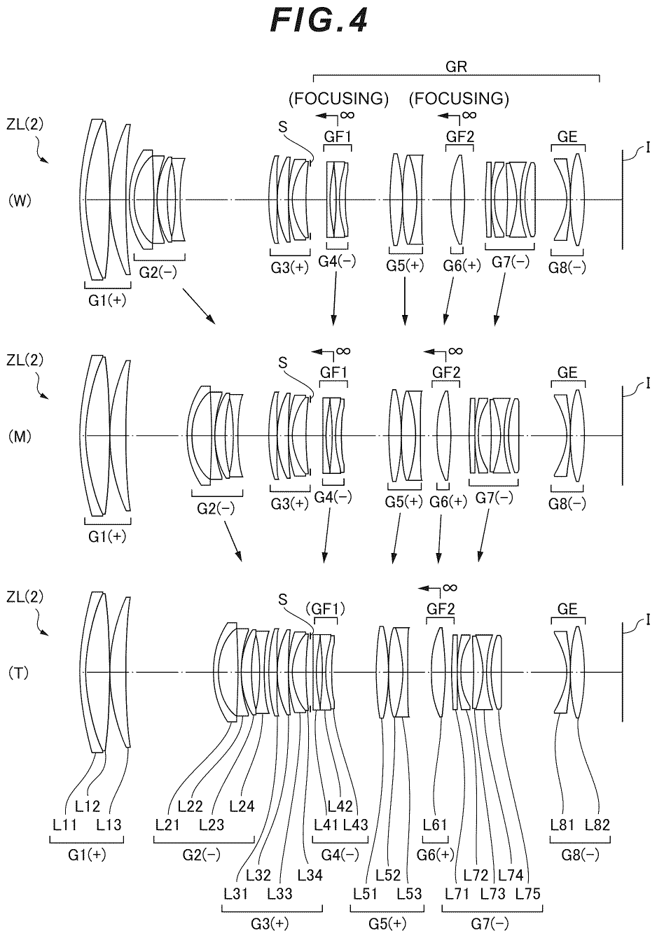

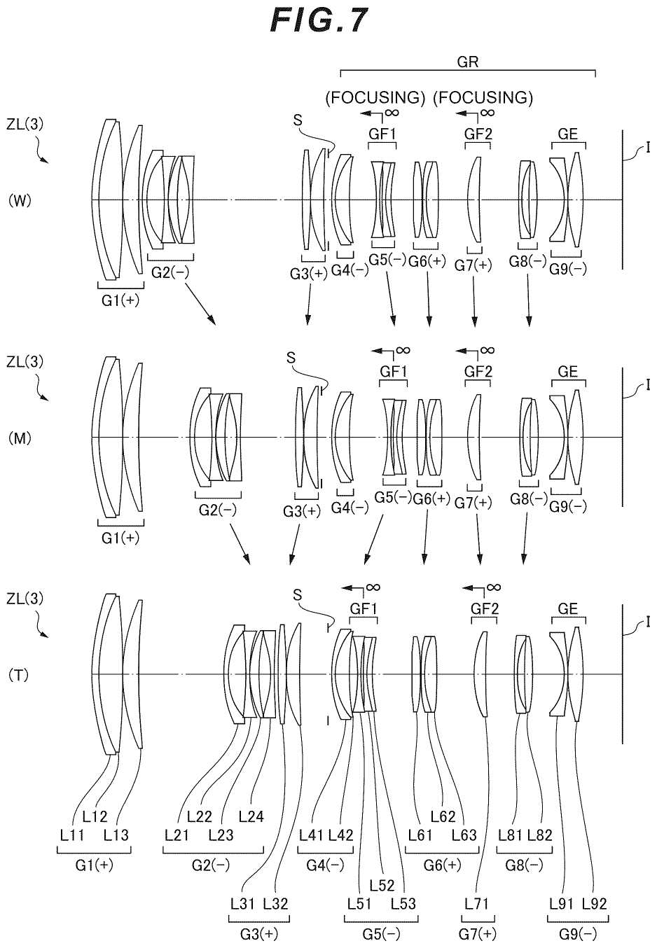

According to the first embodiment, it is possible to obtain a zoom optical system having bright and favorable optical performance while being compact, and an optical device including this zoom optical system. The zoom optical system ZL according to the first embodiment may be a zoom optical system ZL(2) shown in FIG. 4 or may be a zoom optical system ZL(3) shown in FIG. 7.

The conditional expression (1) defines an appropriate relationship between the focal length of the second lens group G2 and the focal length of the first lens group G1. By satisfying the conditional expression (1), spherical aberration, coma aberration, and curvature of field can be favorably corrected.

When a corresponding value of the conditional expression (1) exceeds an upper limit value, the refractive power of the first lens group G1 increases, which complicates correcting spherical aberration, coma aberration, and curvature of field that occur in the first lens group G1. By setting the upper limit value of the conditional expression (1) to 0.80, 0.70, 0.50, 0.40, or further 0.37, it is possible to more reliably achieve the effect of the first embodiment.

When the corresponding value of the conditional expression (1) falls below a lower limit value, the refractive power of the second lens group G2 increases, which complicates correcting spherical aberration, coma aberration, and curvature of field that occur in the second lens group G2. By setting the lower limit value of the conditional expression (1) to 0.10, 0.15, 0.20, 0.25, or further 0.30, it is possible to more reliably achieve the effect of the first embodiment.

The conditional expression (2) defines an appropriate relationship between the back focus of the zoom optical system ZL in the telephoto end state and the focal length of the zoom optical system ZL in the telephoto end state. By satisfying the conditional expression (2), it is possible to obtain a zoom optical system having bright and favorable optical performance while being compact. By setting an upper limit value of the conditional expression (2) to 0.12 or further 0.10, it is possible to more reliably achieve the effect of the first embodiment. By setting a lower limit value of the conditional expression (2) to 0.02, 0.04, or further 0.05, it is possible to more reliably achieve the effect of the first embodiment.

Next, the zoom optical system according to the second embodiment will be described. A zoom optical system ZL according to the second embodiment has a similar configuration to that of the zoom optical system ZL according to the first embodiment and therefore will be described with the same reference signs. As shown in FIG. 1, the zoom optical system ZL(1) as an example of the zoom optical system (zoom lens) ZL according to the second embodiment comprises, in order from the object along the optical axis, the first lens group G1 having positive refractive power, the second lens group G2 having negative refractive power, the third lens group G3 having positive refractive power, and the rear group GR including at least five lens groups. When zooming, the distance between each adjacent lens group changes, and the first lens group G1 is fixed relative to the image surface. The at least five lens groups of the rear group GR include a first focus lens group GF1 having negative refractive power, and a second focus lens group GF2 having positive refractive power and being arranged closer to the image surface than the first focus lens group GF1. When focusing, the first focus lens group GF1 and the second focus lens group GF2 move along the optical axis at different trajectories. Note that a lens group that moves when focusing in a wide-angle end state may be referred to as the first focus lens group GF1, the second focus lens group GF2, . . . , in order from the object.

Based on the above configuration, the zoom optical system ZL according to the second embodiment satisfies the following conditional expression (3) and conditional expression (4).

0.10<(−fF1)/fF2<1.30 (3)

0.01<Bfw/fw<0.50 (4)
Where fF1: a focal length of the first focus lens group GF1,
fF2: a focal length of the second focus lens group GF2,
fw: a focal length of the zoom optical system ZL in the wide-angle end state, and
Bfw: a back focus of the zoom optical system ZL in the wide-angle end state.

According to the second embodiment, it is possible to obtain a zoom optical system having bright and favorable optical performance while being compact, and an optical device including this zoom optical system. The zoom optical system ZL according to the second embodiment may be the zoom optical system ZL(2) shown in FIG. 4 or may be the zoom optical system ZL(3) shown in FIG. 7.

The conditional expression (3) defines an appropriate relationship between the focal length of the first focus lens group GF1 and the focal length of the second focus lens group GF2. By satisfying the conditional expression (3), spherical aberration can be favorably corrected.

When a corresponding value of the conditional expression (3) exceeds an upper limit value, the refractive power of the second focus lens group GF2 increases, which complicates correcting spherical aberration and coma aberration that occurs when focusing. By setting the upper limit value of the conditional expression (3) to 1.20, 1.10, 1.00, 0.90, or further 0.80, it is possible to more reliably achieve the effect of the second embodiment.

When the corresponding value of the conditional expression (3) falls below a lower limit value, the refractive power of the first focus lens group GF1 increases, which complicates correcting spherical aberration that occurs when focusing. By setting the lower limit value of the conditional expression (3) to 0.15, 0.20, 0.25, 0.35, 0.45, or further 0.50, it is possible to more reliably achieve the effect of the second embodiment.

The conditional expression (4) defines an appropriate relationship between the back focus of the zoom optical system ZL in the wide-angle end state and the focal length of the zoom optical system ZL in the wide-angle end state. By satisfying the conditional expression (4), it is possible to obtain a zoom optical system having bright and favorable optical performance while being compact. By setting an upper limit value of the conditional expression (4) to 0.45, 0.40, 0.35, 0.33, 0.30, or further 0.28, it is possible to more reliably achieve the effect of the second embodiment. By setting a lower limit value of the conditional expression (4) to 0.05, 0.10, or further 0.13, it is possible to more reliably achieve the effect of the second embodiment.

The zoom optical system ZL according to the first embodiment may satisfy the above conditional expression (4). By satisfying the conditional expression (4), it is possible to obtain a zoom optical system having bright and favorable optical performance while being compact, similar to the second embodiment. By setting the upper limit value of the conditional expression (4) to 0.45, 0.40, 0.35, 0.33, 0.30, or further 0.28, it is possible to more reliably achieve the effect of the first embodiment. By setting the lower limit value of the conditional expression (4) to 0.05, 0.10, or further 0.13, it is possible to more reliably achieve the effect of the first embodiment.

In the zoom optical system ZL according to the first embodiment, the at least five lens groups of the rear group GR include the first focus lens group GF1 having negative refractive power, and the second focus lens group GF2 having positive refractive power and being arranged closer to the image surface than the first focus lens group GF1 and, when focusing, the first focus lens group GF1 and the second focus lens group GF2 may move along the optical axis at difference trajectories. The zoom optical system ZL according to the first embodiment may satisfy the above conditional expression (3). By satisfying the conditional expression (3), spherical aberration can be favorably corrected, similar to the second embodiment. By setting the upper limit value of the conditional expression (3) to 1.20, 1.10, 1.00, 0.90, or further 0.80, it is possible to more reliably achieve the effect of the first embodiment. By setting the lower limit value of the conditional expression (3) to 0.15, 0.20, 0.25, 0.35, 0.45, or further 0.50, it is possible to more reliably achieve the effect of the first embodiment.

The zoom optical system ZL according to the first embodiment and the second embodiment may satisfy the following conditional expression (5).

0.50<f2/fF1<1.00 (5)
Where f2: the focal length of the second lens group G2.

The conditional expression (5) defines an appropriate relationship between the focal length of the second lens group G2 and the focal length of the second focus lens group GF2. By satisfying the conditional expression (5), spherical aberration can be favorably corrected.

When a corresponding value of the conditional expression (5) exceeds an upper limit value, the refractive power of the first focus lens group GF1 increases, which complicates correcting spherical aberration that occurs when focusing. By setting the upper limit value of the conditional expression (5) to 0.95 or further 0.90, it is possible to more reliably achieve the effect of each embodiment.

When the corresponding value of the conditional expression (5) falls below a lower limit value, the refractive power of the second lens group G2 increases, which complicates correcting spherical aberration, coma aberration, and curvature of field that occur in the second lens group G2. By setting the lower limit value of the conditional expression (5) to 0.60, 0.65, or further 0.70, it is possible to more reliably achieve the effect of each embodiment.

The zoom optical system ZL according to the first embodiment and the second embodiment may satisfy the following conditional expression (6).

1.20<f1/fF2<2.00 (6)
Where f1: the focal length of the first lens group G1.

The conditional expression (6) defines an appropriate relationship between the focal length of the first lens group G1 and the focal length of the second focus lens group GF2. By satisfying the conditional expression (6), spherical aberration and coma aberration can be favorably corrected.

When a corresponding value of the conditional expression (6) exceeds an upper limit value, the refractive power of the second focus lens group GF2 increases, which complicates correcting spherical aberration and coma aberration that occurs when focusing. By setting the upper limit value of the conditional expression (6) to 1.90 or further 1.85, it is possible to more reliably achieve the effect of each embodiment.

When the corresponding value of the conditional expression (6) falls below a lower limit value, the refractive power of the first lens group G1 increases, which complicates correcting spherical aberration, coma aberration, and curvature of field that occur in the first lens group G1. By setting the lower limit value of the conditional expression (6) to 1.25, 1.30, or further 1.35, it is possible to more reliably achieve the effect of each embodiment.

The zoom optical system ZL according to the first embodiment and the second embodiment may satisfy the following conditional expression (7).

0.50<f3/fF2<1.00 (7)
Where f3: a focal length of the third lens group G3.

The conditional expression (7) defines an appropriate relationship between the focal length of the third lens group G3 and the focal length of the second focus lens group GF2. By satisfying the conditional expression (7), spherical aberration and coma aberration can be favorably corrected.

When a corresponding value of the conditional expression (7) exceeds an upper limit value, the refractive power of the second focus lens group GF2 increases, which complicates correcting spherical aberration and coma aberration that occurs when focusing. By setting the upper limit value of the conditional expression (7) to 0.95 or further 0.90, it is possible to more reliably achieve the effect of each embodiment.

When the corresponding value of the conditional expression (7) falls below a lower limit value, the refractive power of the third lens group G3 increases, which complicates correcting spherical aberration, coma aberration, and curvature of field that occur in the third lens group G3. By setting the lower limit value of the conditional expression (7) to 0.60, 0.65, or further 0.70, it is possible to more reliably achieve the effect of each embodiment.

In the zoom optical system ZL according to the first embodiment and the second embodiment, the second focus lens group GF2 may comprise one lens component. With this, it is possible to make the zoom optical system compact and light. Note that in each embodiment, lens component indicates a single lens or a cemented lens. The second focus lens group GF2 may comprise one positive lens. The second focus lens group GF2 may comprise one cemented positive lens.

The zoom optical system ZL according to the first embodiment and the second embodiment may satisfy the following conditional expression (8).

2.00<TLw/fw<6.00 (8)
Where fw: the focal length of the zoom optical system ZL in the wide-angle end state, and
TLw: an entire length of the zoom optical system ZL in the wide-angle end state.

The conditional expression (8) defines an appropriate relationship between the entire length of the zoom optical system ZL in the wide-angle end state and the focal length of the zoom optical system ZL in the wide-angle end state. By satisfying the conditional expression (8), it is possible to obtain a zoom optical system having bright and favorable optical performance while being compact. By setting an upper limit value of the conditional expression (8) to 5.50, 5.00, 4.50, or further 4.00, it is possible to more reliably achieve the effect of each embodiment. By setting a lower limit value of the conditional expression (8) to 2.50, 2.80, 3.00, or further 3.10, it is possible to more reliably achieve the effect of each embodiment.

The zoom optical system ZL according to the first embodiment and the second embodiment may satisfy the following conditional expression (9).

0.01<(−f2)/f3<2.00 (9)
Where f2: the focal length of the second lens group G2, and
f3: the focal length of the third lens group G3.

The conditional expression (9) defines an appropriate relationship between the focal length of the second lens group G2 and the focal length of the third lens group G3. By satisfying the conditional expression (9), spherical aberration, coma aberration, and curvature of field can be favorably corrected.

When a corresponding value of the conditional expression (9) exceeds an upper limit value, the refractive power of the third lens group G3 increases, which complicates correcting spherical aberration, coma aberration, and curvature of field that occur in the third lens group G3. By setting the upper limit value of the conditional expression (9) to 1.80, 1.60, 1.50, 1.35, 1.10, or further 1.00, it is possible to more reliably achieve the effect of the present embodiment.

When the corresponding value of the conditional expression (9) falls below a lower limit value, the refractive power of the second lens group G2 increases, which complicates correcting spherical aberration, coma aberration, and curvature of field that occur in the second lens group G2. By setting the lower limit value of the conditional expression (9) to 0.10, 0.20, 0.30, 0.35, 0.45, 0.50, or further 0.55, it is possible to more reliably achieve the effect of the present embodiment.

The zoom optical system ZL according to the first embodiment and the second embodiment may satisfy the following conditional expression (10).

1.80<f1/f3<2.50 (10)
Where f1: the focal length of the first lens group G1, and
f3: the focal length of the third lens group G3.

The conditional expression (10) defines an appropriate relationship between the focal length of the first lens group G1 and the focal length of the third lens group G3. By satisfying the conditional expression (10), spherical aberration, coma aberration, and curvature of field can be favorably corrected.

When a corresponding value of the conditional expression (10) exceeds an upper limit value, the refractive power of the third lens group G3 increases, which complicates correcting spherical aberration, coma aberration, and curvature of field that occur in the third lens group G3. By setting the upper limit value of the conditional expression (10) to 2.45, 2.40, or further 2.35, it is possible to more reliably achieve the effect of the present embodiment.

When the corresponding value of the conditional expression (10) falls below a lower limit value, the refractive power of the first lens group G1 increases, which complicates correcting spherical aberration, coma aberration, and curvature of field that occur in the first lens group G1. By setting the lower limit value of the conditional expression (10) to 1.85 or further 1.90, it is possible to more reliably achieve the effect of the present embodiment.

In the zoom optical system ZL according to the first embodiment and the second embodiment, the at least five lens groups of the rear group GR include a final lens group GE arranged closest to the image surface, and may satisfy the following conditional expression (11).

0.01<|fr1/fr|<5.00 (11)
Where fr: a focal length of the final lens group GE, and
fr1: a focal length of the final lens group GE in the rear group GR.

The conditional expression (11) defines an appropriate relationship between the focal length of the lens group arranged in order from the object of the final lens group GE in the rear group GR, and the focal length of the final lens group GE. By satisfying the conditional expression (11), curvature of field can be favorably corrected.

When a corresponding value of the conditional expression (11) exceeds an upper limit value, a refractive power of the final lens group GE increases, which complicates correcting curvature of field that occurs in the final lens group GE. By setting the upper limit value of the conditional expression (11) to 4.80, 4.50, 4.30, 3.50, 3.30, 3.00, 2.80, or further 2.50, it is possible to more reliably achieve the effect of the present embodiment.

When the corresponding value of the conditional expression (11) falls below a lower limit value, a refractive power of the lens group arranged in order from the object of the final lens group GE in the rear group GR increases, which complicates correcting coma aberration and curvature of field that occur in the lens group arranged in order from the object of the final lens group GE. By setting the lower limit value of the conditional expression (11) to 0.10, 0.20, 0.25, 0.35, 0.45, or further 0.50, it is possible to more reliably achieve the effect of the present embodiment.

In the zoom optical system ZL according to the first embodiment and the second embodiment, the at least five lens groups of the rear group GR include the final lens group GE arranged closest to the image surface, and may satisfy the following conditional expression (12).

0.10<f2/fr1<0.75 (12)
Where f2: the focal length of the second lens group G2, and
fr1: a focal length of the final lens group GE in the rear group GR.

The conditional expression (12) defines an appropriate relationship between the focal length of the second lens group G2, and the focal length of the lens group arranged in order from the object of the final lens group GE in the rear group GR. By satisfying the conditional expression (12), coma aberration and curvature of field can be favorably corrected.

When a corresponding value of the conditional expression (12) exceeds an upper limit value, the refractive power of the lens group arranged in order from the object of the final lens group GE in the rear group GR increases, which complicates correcting coma aberration and curvature of field that occur in the lens group arranged in order from the object of the final lens group GE. By setting the upper limit value of the conditional expression (12) to 0.70 or further 0.68, it is possible to more reliably achieve the effect of the present embodiment.

When the corresponding value of the conditional expression (12) falls below a lower limit value, the refractive power of the second lens group G2 increases, which complicates correcting spherical aberration, coma aberration, and curvature of field that occur in the second lens group G2. By setting the lower limit value of the conditional expression (12) to 0.15 or further 0.20, it is possible to more reliably achieve the effect of the present embodiment.

In the zoom optical system ZL according to the first embodiment and the second embodiment, the at least five lens groups of the rear group GR include the final lens group GE arranged closest to the image surface and, when zooming, the final lens group GE may be fixed relative to the image surface I. With this, it is possible to make the zoom optical system compact.

In the zoom optical system ZL according to the first embodiment and the second embodiment, the at least five lens groups of the rear group GR include the final lens group GE arranged closest to the image surface and the final lens group GE may comprise, in order from the object along the optical axis, a negative lens and a positive lens. With this, chromatic aberration can be favorably corrected.

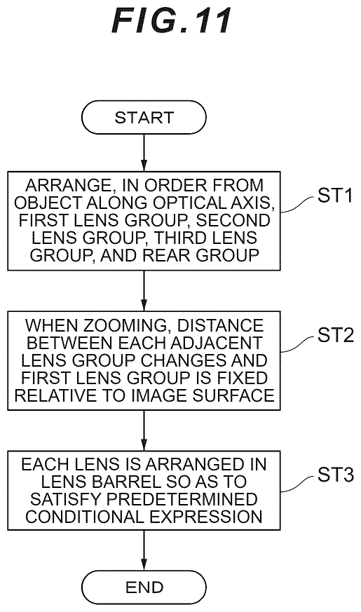

Next, a method of manufacturing the zoom optical system ZL according to the first embodiment will be described with reference to FIG. 11. First, the first lens group G1 having positive refractive power, the second lens group G2 having negative refractive power, the third lens group G3 having positive refractive power, and the rear group GR are arranged in order from the object along the optical axis (step ST1). At this time, the at least five lens groups are arranged in the rear group GR. Next, when zooming, the distance between each adjacent lens group changes, and the first lens group G1 is fixed relative to the image surface I (step ST2). Each lens is arranged in a lens barrel so as to satisfy at least the above conditional expression (1) and conditional expression (2) (step ST3). According to such a manufacturing method, it is possible to manufacture a zoom optical system having bright and favorable optical performance while being compact.

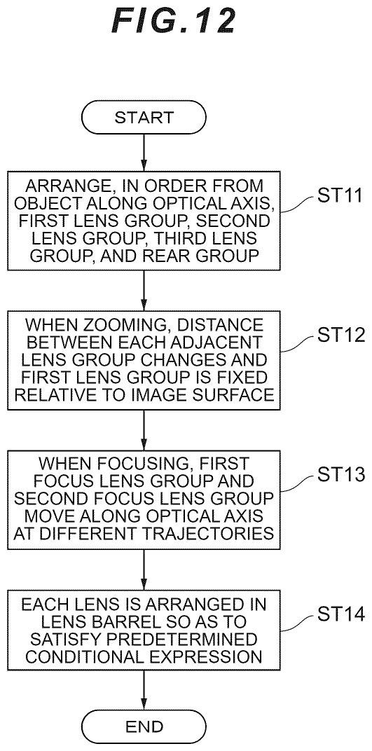

Next, a method of manufacturing the zoom optical system ZL according to the second embodiment will be described with reference to FIG. 12. First, the first lens group G1 having positive refractive power, the second lens group G2 having negative refractive power, the third lens group G3 having positive refractive power, and the rear group GR are arranged in order from the object along the optical axis (step ST11). At this time, the at least five lens groups that include the first focus lens group GF1 having negative refractive power, and the second focus lens group GF2 having positive refractive power and being arranged closer to the image surface than the first focus lens group GF1 are arranged in the rear group GR. Next, when zooming, the distance between each adjacent lens group changes, and the first lens group G1 is fixed relative to the image surface I (step ST12). When focusing, the first focus lens group GF1 and the second focus lens group GF2 move along the optical axis at different trajectories (step ST13). Each lens is arranged in a lens barrel so as to satisfy at least the above conditional expression (3) and conditional expression (4) (step ST14). According to such a manufacturing method, it is possible to manufacture a zoom optical system having bright and favorable optical performance while being compact.

### EXAMPLES

Hereinafter, the zoom optical system ZL according to examples of each embodiment will be described. FIGS. 1, 4, and 7 are cross-sectional diagrams showing configurations and refractive power distributions of the zoom optical system ZL {ZL(1) to ZL(3)} according to first to third examples. The cross-sectional diagrams of the zoom optical systems ZL(1) to ZL(3) according to the first to third examples show, using arrows, a movement direction of each lens group when zooming from the wide-angle end state (W) to the telephoto end state. A movement direction of the focus lens group when focusing from infinity to a short-distance object is indicated with an arrow along with the word “focusing”.

In FIGS. 1, 4, and 7, each lens group is represented by a combination of a reference sign G and a numeral, and each lens is represented by a combination of a reference sign L and a numeral. In this case, in order to prevent complication due to an increase in the types and number of reference signs and numerals, the lens groups and the like are represented using a combination of a reference sign and a numeral independently for each example. Accordingly, even if the same combination of a reference sign and a numeral is used among the examples, such use does not intend to mean the same configuration.

Hereinafter, Tables 1 to 3 are shown. Table 1 shows each piece of data for the first example, Table 2 for the second example, and Table 3 for the third example. In each example, a d-line (wavelength λ=587.6 nm) and a g-line (wavelength λ=435.8 nm) are selected as calculation targets of aberration characteristics.

In the [General Data] table, f indicates a focal length of an entire lens system, FNO indicates an F-number, ω indicates a half angle of view (unit thereof is ° (degrees), and Y indicates an image height. TL indicates a distance obtained by adding Bf (back focus) to a distance on the optical axis from a lens surface closest to the object to a lens surface closest to the image surface of the zoom optical system upon focusing on infinity. Bf indicates a distance on the optical axis from a lens surface closest to the image surface to the image surface of the zoom optical system upon focusing on infinity. Note that these values are indicated for each zoom state, namely the wide-angle end state (W), the medium focal length state (M), and the telephoto end state (T).

In the [Lens Data] table, a surface number indicates an order of optical surfaces from the object along a direction in which a light beam travels, R indicates a radius of curvature of each optical surface (a surface whose center of curvature is located at an image side is defined as a positive value), D indicates a surface distance being a distance on the optical axis from each optical surface to the next optical surface (or image surface), nd indicates a refractive index of a material of an optical member for the d-line, and vd indicates an Abbe number of the material of the optical member with respect to the d-line, respectively. A radius of curvature of “∞” indicates a plane or an opening, and (aperture stop S) indicates an aperture stop S, respectively. Description of the refractive index nd of air=1.00000 is omitted. When the optical surface is an aspherical surface, a * symbol is assigned to the surface number, and a paraxial radius of curvature is shown in a radius of curvature R column.

In the [Aspherical surface data] table, a shape of an aspherical surface shown in [Lens Data] is indicated by the following expression (A). X(y) indicates a distance (sag amount) from a tangent plane at a vertex of the aspherical surface to a position on the aspherical surface at a height y along an optical axis direction. R indicates the radius of curvature (paraxial radius of curvature) of a reference spherical surface. K indicates a conic constant. Ai indicates an i-th aspherical coefficient. “E-n” indicates “×10⁻ⁿ”. For example, 1.234E-05=1.234×10⁻⁵. Note that a secondary aspherical coefficient A2 is 0, and description thereof is omitted.

X(y)=(y²/R)/{1+(1−K×y²/R²)^{1/2}}+A4×y⁴+A6×y⁶+A8×y⁸+A10×y¹⁰ (A)

The [Variable distance data] table shows surface distances at a surface number i where a surface distance is (Di) in the [Lens Data] table. The [Variable distance data] table shows surface distances upon focusing on infinity and surface distances upon focusing on a short-distance object. D0 indicates a distance from the object to a lens surface closest to the object in the zoom optical system.

The [Lens group data] table shows a first surface (surface closest to the object) of each lens group and the focal length.

Hereinafter, among all data values, “mm” is generally used for the focal length f, radius of curvature R, surface distance D, other lengths, and the like listed when not otherwise specified. However, since the optical system can achieve equivalent optical performance even when being proportionally enlarged or reduced, the optical system is not limited thereto.

The description of the tables up to this point is shared between all of the examples, and hereinafter, overlapping description is omitted.

### First Example

The first example will be described with reference to FIGS. 1 to 3 and Table 1. FIG. 1 is a diagram showing a lens configuration of the zoom optical system according to the first example. The zoom optical system ZL(1) according to the first example comprises, in order from the object along the optical axis, the first lens group G1 having positive refractive power, the second lens group G2 having negative refractive power, the third lens group G3 having positive refractive power, a fourth lens group G4 having negative refractive power, a fifth lens group G5 having positive refractive power, a sixth lens group G6 having positive refractive power, a seventh lens group G7 having positive refractive power, an eighth lens group G8 having negative refractive power, and a ninth lens group G9 having positive refractive power. When zooming from the wide-angle end state (W) to the telephoto end state (T), the second lens group G2, the fourth lens group G4, the fifth lens group G5, the sixth lens group G6, the seventh lens group G7, and the eighth lens group G8 move along the optical axis as indicated by the arrows in FIG. 1, and the distance between each adjacent lens group changes. Note that when zooming, the first lens group G1, the third lens group G3, and the ninth lens group G9 are fixed relative to the image surface I. Also, the aperture stop S is arranged between the third lens group G3 and the fourth lens group G4, and the aperture stop S is fixed relative to the image surface I along with the third lens group G3 when zooming. The reference signs (+) or (−) assigned to each lens group symbol indicate the refractive power of each lens group, and this applies to all of the following examples.

The first lens group G1 comprises, in order from the object along the optical axis, a cemented positive lens obtained by cementing together a meniscus-shaped negative lens L11 having a convex surface facing the object and a biconvex positive lens L12, and a meniscus-shaped positive lens L13 having a convex surface facing the object.

The second lens group G2 comprises, in order from the object along the optical axis, a meniscus-shaped negative lens L21 having a convex surface facing the object, a biconcave negative lens L22, a meniscus-shaped positive lens L23 having a convex surface facing the object, and a biconcave negative lens L24.

The third lens group G3 comprises, in order from the object along the optical axis, a meniscus-shaped positive lens L31 having a convex surface facing the object, a meniscus-shaped positive lens L32 having a convex surface facing the object, and a cemented positive lens obtained by cementing together a meniscus-shaped negative lens L33 having a convex surface facing the object and a meniscus-shaped positive lens L34 having a convex surface facing the object.

The fourth lens group G4 comprises, in order from the object along the optical axis, a biconcave negative lens L41, and a cemented negative lens obtained by cementing together a biconcave negative lens L42 and a meniscus-shaped positive lens L43 having a convex surface facing the object.

The fifth lens group G5 comprises, in order from the object along the optical axis, a biconvex positive lens L51, and a cemented positive lens obtained by cementing together a biconvex positive lens L52 and a biconcave negative lens L53. An object-side lens surface of the positive lens L51 is an aspherical surface.

The sixth lens group G6 comprises a biconvex positive lens L61.

The seventh lens group G7 comprises, in order from the object along the optical axis, a meniscus-shaped positive lens L71 having a concave surface facing the object, a meniscus-shaped negative lens L72 having a convex surface facing the object, a cemented negative lens obtained by cementing together a biconvex positive lens L73 and a biconcave negative lens L74, and a biconvex positive lens L75. An image surface-side lens surface of the meniscus-shaped negative lens L72 is an aspherical surface.

The eighth lens group G8 comprises a meniscus-shaped negative lens L81 having a concave surface facing the object.

The ninth lens group G9 comprises, in order from the object along the optical axis, a meniscus-shaped negative lens L91 having a concave surface facing the object and a biconvex positive lens L92. The image surface I is arranged on the image side from the ninth lens group G9.

In the present example, the fourth lens group G4, the fifth lens group G5, the sixth lens group G6, the seventh lens group G7, the eighth lens group G8, and the ninth lens group G9 constitute the rear group GR. In the rear group GR, the fourth lens group G4 corresponds to the first focus lens group GF1, and the sixth lens group G6 corresponds to the second focus lens group GF2. The eighth lens group G8 corresponds to the third focus lens group GF3, and the ninth lens group G9 corresponds to the final lens group GE. When focusing from an infinity object to the short-distance object in the wide-angle end state, the first focus lens group GF1 (fourth lens group G4) and the third focus lens group GF3 (eighth lens group G8) move toward the image surface along the optical axis at different trajectories (movement amounts), and the second focus lens group GF2 (sixth lens group G6) moves toward the object along the optical axis. When focusing from the infinity object to the short-distance object in a medium focal length state and the telephoto end state, the first focus lens group GF1 (fourth lens group G4) and the second focus lens group GF2 (sixth lens group G6) move toward the object along the optical axis at different trajectories (movement amounts), and the third focus lens group GF3 (eighth lens group G8) moves toward the image surface along the optical axis.

Data values of the zoom optical system according to the first example are listed in the following Table 1.

TABLE 1
[General Data]
Zooming ratio = 2.796

| | W | M | T |
|---|---|---|---|
| f | 71.548 | 135.050 | 200.028 |
| FNO | 2.880 | 2.880 | 2.880 |
| ω | 16.511 | 8.764 | 5.920 |
| Y | 21.700 | 21.700 | 21.700 |
| TL | 250.032 | 250.032 | 250.032 |
| Bf | 11.741 | 11.741 | 11.741 |

[Lens Data]

| Surface | | | | |
|---|---|---|---|---|
| Number | R | D | nd | νd |
| 1 | 122.864 | 2.800 | 2.00100 | 29.12 |
| 2 | 90.022 | 10.167 | 1.43700 | 95.10 |
| 3 | −414.107 | 0.234 | | |
| 4 | 77.712 | 7.561 | 1.49782 | 82.57 |
| 5 | 295.979 | (D5) | | |
| 6 | 56.998 | 1.900 | 1.80400 | 46.60 |
| 7 | 31.804 | 7.084 | | |
| 8 | −4966.831 | 1.700 | 1.59319 | 67.90 |
| 9 | 67.160 | 0.100 | | |
| 10 | 44.520 | 4.643 | 1.78880 | 28.43 |
| 11 | 110.699 | 4.209 | | |
| 12 | −79.535 | 1.938 | 1.59319 | 67.90 |
| 13 | 145.761 | (D13) | | |
| 14 | 158.706 | 2.960 | 1.85000 | 27.03 |
| 15 | 1838.648 | 0.100 | | |
| 16 | 51.122 | 5.386 | 1.59319 | 67.90 |
| 17 | 376.813 | 0.248 | | |
| 18 | 53.979 | 1.988 | 1.95000 | 29.37 |
| 19 | 31.619 | 6.264 | 1.59319 | 67.90 |
| 20 | 125.967 | 2.816 | | |
| 21 | ∞ | (D21) | (Aperture | |
| | | | Stop S) | |
| 22 | −323.008 | 1.690 | 1.48749 | 70.32 |
| 23 | 48.793 | 4.205 | | |
| 24 | −102.551 | 1.630 | 1.72916 | 54.61 |
| 25 | 66.748 | 3.370 | 1.94595 | 17.98 |
| 26 | 261.516 | (D26) | | |
| 27* | 109.977 | 5.481 | 1.72916 | 54.61 |
| 28 | −79.623 | 0.100 | | |
| 29 | 111.650 | 6.633 | 1.55032 | 75.50 |
| 30 | −51.225 | 1.922 | 1.84666 | 23.80 |
| 31 | 147.362 | (D31) | | |
| 32 | 56.533 | 5.446 | 1.59319 | 67.90 |
| 33 | −217.682 | (D33) | | |
| 34 | −2926.248 | 2.671 | 1.72916 | 54.61 |
| 35 | −141.449 | 0.104 | | |
| 36 | 60.090 | 1.504 | 1.90265 | 35.77 |
| 37* | 34.056 | 5.025 | | |
| 38 | 489.405 | 4.385 | 1.95000 | 29.37 |
| 39 | −55.620 | 1.609 | 1.81600 | 46.59 |
| 40 | 49.501 | 2.112 | | |
| 41 | 43.776 | 5.208 | 1.69895 | 30.13 |
| 42 | −284.027 | (D42) | | |
| 43 | −59.154 | 1.545 | 1.95375 | 32.33 |
| 44 | −465.956 | (D44) | | |
| 45 | −28.519 | 1.736 | 1.88300 | 40.69 |
| 46 | −49.853 | 0.105 | | |
| 47 | 531.811 | 5.623 | 1.75211 | 25.05 |
| 48 | −64.326 | Bf | | |

[Aspherical Surface Data]
27th surface
κ = 1.000, A4 = −1.64920E−06, A6 = 3.15497E−10,
A8 = −5.63176E−13, A10 = 5.03223E−16
37th surface
κ = 1.000, A4 = −5.24407E−07, A6 = 1.13434E−10,
A8 = −1.32855E−12, A10 = 4.32537E−15

[Variable Distance Data]
Upon focusing on infinity

| | W | M | T |
|---|---|---|---|
| Focal length | 71.548 | 135.050 | 200.028 |
| D0 | ∞ | ∞ | ∞ |
| D5 | 1.500 | 27.147 | 41.533 |
| D13 | 41.615 | 15.968 | 1.581 |
| D21 | 1.873 | 2.684 | 1.943 |
| D26 | 24.719 | 19.898 | 17.795 |
| D31 | 6.344 | 6.130 | 11.214 |
| D33 | 8.357 | 6.869 | 2.414 |
| D42 | 17.020 | 18.526 | 16.675 |
| D44 | 12.661 | 16.866 | 20.933 |
| Bf | 11.741 | 11.741 | 11.741 |

Upon focusing on a short-distance object

| | W | M | T |
|---|---|---|---|
| Zoom | −0.205 | −0.147 | −0.165 |
| magnification | | | |
| D0 | 250.000 | 700.000 | 900.000 |
| D5 | 1.500 | 27.147 | 41.533 |
| D13 | 41.615 | 15.968 | 1.581 |
| D21 | 2.113 | 2.058 | 1.863 |
| D26 | 24.478 | 20.524 | 17.874 |
| D31 | 2.094 | 1.600 | 3.491 |
| D33 | 12.607 | 11.399 | 10.137 |
| D42 | 23.533 | 28.326 | 31.299 |
| D44 | 6.149 | 7.066 | 6.310 |
| Bf | 11.741 | 11.741 | 11.741 |

[Lens Group Data]

| Group | First surface | Focal length |
|---|---|---|
| G1 | 1 | 130.513 |
| G2 | 6 | −45.453 |
| G3 | 14 | 57.730 |
| G4 | 22 | −51.346 |
| G5 | 27 | 97.646 |
| G6 | 32 | 76.219 |
| G7 | 34 | 987.656 |
| G8 | 43 | −71.174 |
| G9 | 45 | 849.550 |

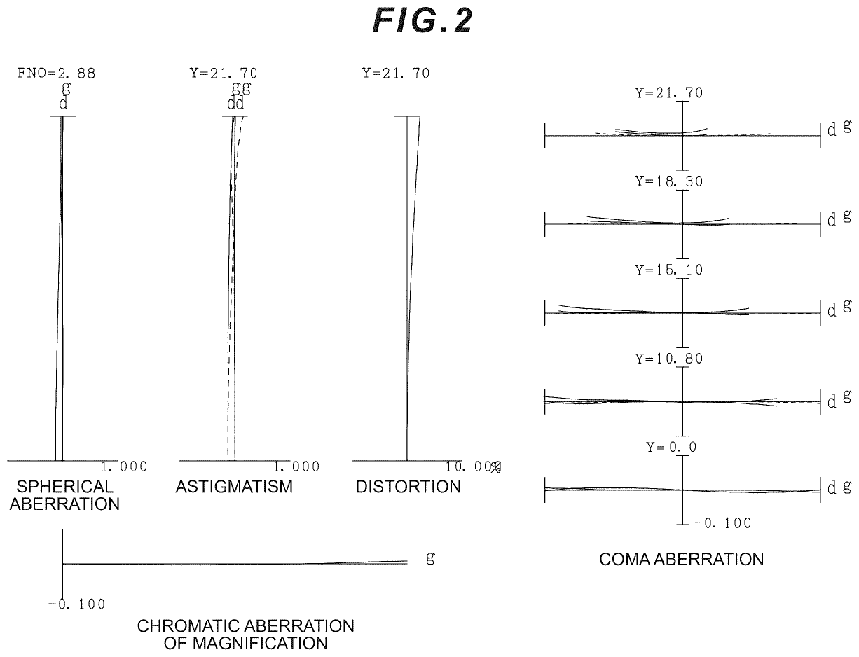

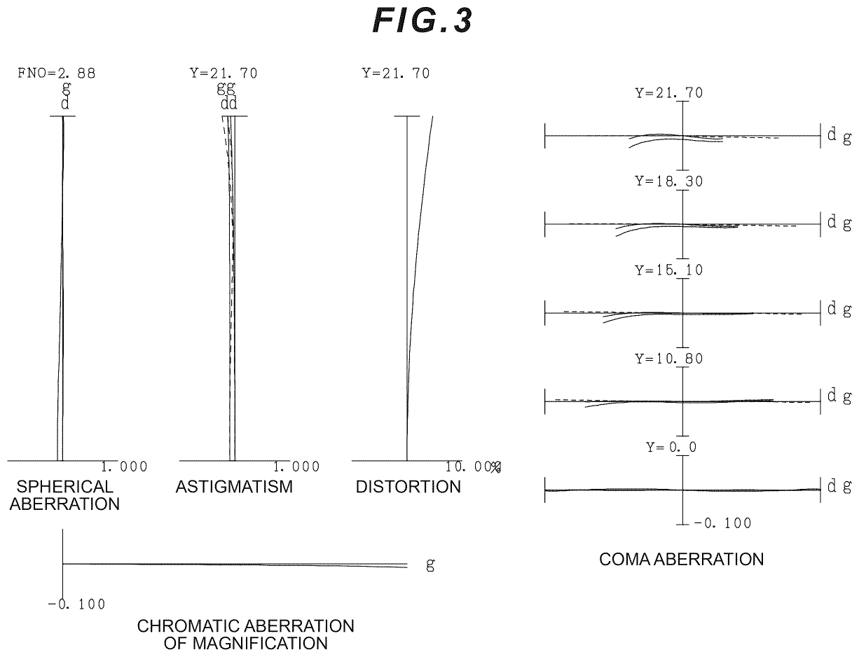

FIG. 2 illustrates graphs showing various aberrations upon focusing on infinity in the wide-angle end state of the zoom optical system according to the first example. FIG. 3 illustrates graphs showing various aberrations upon focusing on infinity in the telephoto end state of the zoom optical system according to the first example. In the aberration graphs, FNO indicates the F-number and Y indicates the image height, respectively. Note that the spherical aberration graphs show a value of e F-number corresponding to a maximum aperture, the astigmatism and distortion graphs each show a maximum value of the image height, respectively. The coma aberration graphs show each image height value. d indicates the d-line (wavelength Δ=587.6 nm) and g indicates the g-line (wavelength λ=435.8 nm), respectively. In the astigmatism graphs, a solid line indicates a sagittal image surface and a dashed line indicates a meridional image surface. Note that in the aberration graphs of each example shown hereinafter, the same reference signs are used as in the present example, and overlapping description is omitted.

As is apparent from the graphs showing various aberrations, the zoom optical system according to first example can favorably correct various aberrations from the wide-angle end state to the telephoto end state, and has superior image formation performance.

### Second Example

The second example will be described with reference to FIGS. 4 to 6 and Table 2. FIG. 4 is a diagram showing a lens configuration of the zoom optical system according to the second example. The zoom optical system ZL(2) according to the second example comprises, in order from the object along the optical axis, the first lens group G1 having positive refractive power, the second lens group G2 having negative refractive power, the third lens group G3 having positive refractive power, the fourth lens group G4 having negative refractive power, the fifth lens group G5 having positive refractive power, the sixth lens group G6 having positive refractive power, the seventh lens group G7 having negative refractive power, and the eighth lens group G8 having negative refractive power. When zooming from the wide-angle end state (W) to the first telephoto end state (T), the second lens group G2, the fourth lens group G4, the fifth lens group G5, the sixth lens group G6, and the seventh lens group G7 move along the optical axis as indicated by the arrows in FIG. 4, and the distance between each adjacent lens group changes. Note that when zooming, the first lens group G1, the third lens group G3, and the eighth lens group G8 are fixed relative to the image surface I. The aperture stop S is arranged between the third lens group G3 and the fourth lens group G4, and the aperture stop S is fixed relative to the image surface I along with the third lens group G3 when zooming.

The first lens group G1 comprises, in order from the object along the optical axis, the cemented positive lens obtained by cementing together the meniscus-shaped negative lens L11 having a convex surface facing the object and the biconvex positive lens L12, and the meniscus-shaped positive lens L13 having a convex surface facing the object.

The second lens group G2 comprises, in order from the object along the optical axis, the meniscus-shaped negative lens L21 having a convex surface facing the object, the biconcave negative lens L22, the meniscus-shaped positive lens L23 having a convex surface facing the object, and the biconcave negative lens L24.

The third lens group G3 comprises, in order from the object along the optical axis, the meniscus-shaped positive lens L31 having a convex surface facing the object, the meniscus-shaped positive lens L32 having a convex surface facing the object, and the cemented positive lens obtained by cementing together the meniscus-shaped negative lens L33 having a convex surface facing the object and the meniscus-shaped positive lens L34 having a convex surface facing the object.

The fourth lens group G4 comprises, in order from the object along the optical axis, a meniscus-shaped negative lens L41 having a convex surface facing the object, and a cemented negative lens obtained by cementing together the biconcave negative lens L42 and the meniscus-shaped positive lens L43 having a convex surface facing the object.

The fifth lens group G5 comprises, in order from the object along the optical axis, the biconvex positive lens L51, and the cemented positive lens obtained by cementing together the biconvex positive lens L52 and the biconcave negative lens L53. The object-side lens surface of the positive lens L51 is an aspherical surface.

The sixth lens group G6 comprises the biconvex positive lens L61.

The seventh lens group G7 comprises, in order from the object along the optical axis, a biconvex positive lens L71, the meniscus-shaped negative lens L72 having a convex surface facing the object, a cemented negative lens obtained by cementing together a meniscus-shaped positive lens L73 having a concave surface facing the object and the biconcave negative lens L74, and the biconvex positive lens L75. The image surface-side lens surface of the meniscus-shaped negative lens L72 is an aspherical surface.

The eighth lens group G8 comprises, in order from the object along the optical axis, the meniscus-shaped negative lens L81 having a concave surface facing the object and a biconvex positive lens L82. The image surface I is arranged on the image side from the eighth lens group G8.

In the present example, the fourth lens group G4, the fifth lens group G5, the sixth lens group G6, the seventh lens group G7, and the eighth lens group G8 constitute the rear group GR. In the rear group GR, the fourth lens group G4 corresponds to the first focus lens group GF1, and the sixth lens group G6 corresponds to the second focus lens group GF2. The eighth lens group G8 corresponds to the final lens group GE. When focusing from the infinity object to the short-distance object in the wide-angle end state and the medium focal length state, the first focus lens group GF1 (fourth lens group G4) and the second focus lens group GF2 (sixth lens group G6) move toward the object along the optical axis at different trajectories (movement amounts). When focusing from the infinity object to the short-distance object in the telephoto end state, only the second focus lens group GF2 (sixth lens group G6) moves toward the object along the optical axis.

Data values of the zoom optical system according to the second example are listed in the following Table 2.

TABLE 2
[General Data]
Zooming ratio = 2.796

| | W | M | T |
|---|---|---|---|
| f | 71.533 | 135.021 | 199.988 |
| FNO | 2.880 | 2.880 | 2.880 |
| ω | 16.505 | 8.743 | 5.900 |
| Y | 21.700 | 21.700 | 21.700 |
| TL | 250.011 | 250.011 | 250.011 |
| Bf | 17.789 | 17.789 | 17.789 |

[Lens Data]

| Surface | | | | |
|---|---|---|---|---|
| Number | R | D | nd | νd |
| 1 | 114.544 | 2.800 | 2.00100 | 29.12 |
| 2 | 83.656 | 10.935 | 1.43700 | 95.10 |
| 3 | −325.490 | 0.100 | | |
| 4 | 76.421 | 7.548 | 1.49782 | 82.57 |
| 5 | 301.176 | (D5) | | |
| 6 | 42.823 | 2.000 | 1.80420 | 46.50 |
| 7 | 27.561 | 9.202 | | |
| 8 | −421.746 | 1.800 | 1.59282 | 68.62 |
| 9 | 55.874 | 0.100 | | |
| 10 | 37.770 | 4.827 | 1.78880 | 28.43 |
| 11 | 101.335 | 3.721 | | |
| 12 | −78.344 | 1.781 | 1.59282 | 68.62 |
| 13 | 78.190 | (D13) | | |
| 14 | 77.705 | 3.571 | 1.84666 | 23.80 |
| 15 | 360.519 | 0.100 | | |
| 16 | 40.850 | 5.243 | 1.59282 | 68.62 |
| 17 | 212.184 | 0.100 | | |
| 18 | 66.204 | 1.728 | 2.00100 | 29.12 |
| 19 | 26.080 | 6.325 | 1.59282 | 68.62 |
| 20 | 129.745 | 2.463 | | |
| 21 | ∞ | (D21) | (Aperture | |
| | | | Stop S) | |
| 22 | 862.907 | 1.523 | 1.51860 | 69.89 |
| 23 | 86.284 | 2.756 | | |
| 24 | −83.791 | 1.498 | 1.72916 | 54.61 |
| 25 | 59.685 | 2.642 | 1.95906 | 17.47 |
| 26 | 103.445 | (D26) | | |
| 27* | 98.633 | 6.161 | 1.72916 | 54.68 |
| 28 | −77.363 | 0.100 | | |
| 29 | 114.635 | 6.339 | 1.55032 | 75.50 |
| 30 | −67.817 | 1.943 | 1.85451 | 25.15 |
| 31 | 389.754 | (D31) | | |
| 32 | 54.843 | 6.404 | 1.59282 | 68.62 |
| 33 | −147.636 | (D33) | | |
| 34 | 222.852 | 2.429 | 1.71300 | 53.87 |
| 35 | −1960.235 | 0.100 | | |
| 36 | 82.264 | 1.500 | 1.91082 | 35.25 |
| 37* | 30.467 | 5.759 | | |
| 38 | −459.309 | 4.400 | 2.00100 | 29.12 |
| 39 | −45.938 | 1.599 | 1.81600 | 46.62 |
| 40 | 54.968 | 2.000 | | |
| 41 | 45.009 | 5.060 | 1.68948 | 31.02 |
| 42 | −473.780 | (D42) | | |
| 43 | −29.972 | 1.625 | 1.95375 | 32.33 |
| 44 | −103.892 | 0.100 | | |
| 45 | 78.373 | 6.295 | 1.62004 | 36.30 |
| 46 | −97.421 | Bf | | |

[Aspherical Surface Data]
27th surface
κ = 1.000, A4 = −2.00672E−06, A6 = 2.68755E−10,
A8 = −3.53434E−13, A10 = 2.25579E−16
37th surface
κ = 1.000, A4 = −6.78662E−07, A6 = −6.07215E−10,
A8 = −3.52567E−13, A10 = 6.36352E−16

[Variable Distance Data]
Upon focusing on infinity

| | W | M | T |
|---|---|---|---|
| Focal length | 71.533 | 135.021 | 199.988 |
| D0 | ∞ | ∞ | ∞ |
| D5 | 1.500 | 28.444 | 40.741 |
| D13 | 40.741 | 13.797 | 1.500 |
| D21 | 7.342 | 5.711 | 1.500 |
| D26 | 20.555 | 21.704 | 20.556 |
| D31 | 13.313 | 7.408 | 10.778 |
| D33 | 9.991 | 8.837 | 3.084 |
| D42 | 14.203 | 21.743 | 29.486 |
| Bf | 17.789 | 17.789 | 17.789 |

Upon focusing on a short-distance object

| | W | M | T |
|---|---|---|---|
| Zoom | −0.199 | −0.139 | −0.174 |
| magnification | | | |
| D0 | 250.000 | 700.000 | 900.000 |
| D5 | 1.500 | 28.444 | 40.741 |
| D13 | 40.741 | 13.797 | 1.500 |
| D21 | 5.071 | 1.500 | 1.500 |
| D26 | 22.826 | 25.916 | 20.556 |
| D31 | 9.035 | 2.906 | 1.492 |
| D33 | 14.269 | 13.340 | 12.370 |
| D42 | 14.203 | 21.743 | 29.486 |
| Bf | 17.789 | 17.789 | 17.789 |

[Lens Group Data]

| Group | First surface | Focal length |
|---|---|---|
| G1 | 1 | 122.121 |
| G2 | 6 | −39.013 |
| G3 | 14 | 60.126 |
| G4 | 22 | −50.190 |
| G5 | 27 | 65.085 |
| G6 | 32 | 68.258 |
| G7 | 34 | −105.133 |
| G8 | 43 | −135.867 |

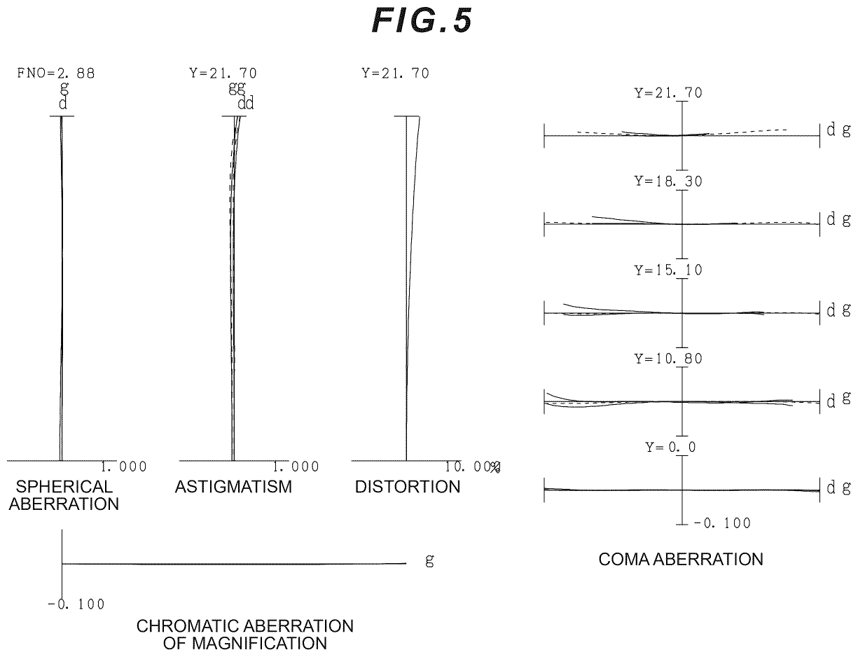

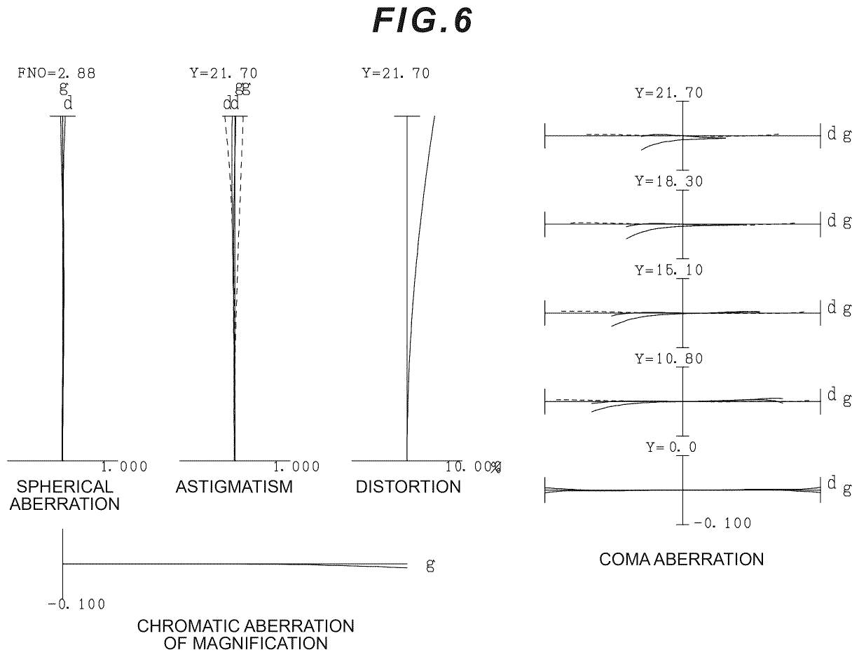

FIG. 5 illustrates graphs showing various aberrations upon focusing on infinity in the wide-angle end state of the zoom optical system according to the second example. FIG. 6 illustrates graphs showing various aberrations upon focusing on infinity in the telephoto end state of the zoom optical system according to the second example. As is apparent from the graphs showing various aberrations, the zoom optical system according to second example can favorably correct various aberrations from the wide-angle end state to the telephoto end state, and has superior image formation performance.

### Third Example

The third example will be described with reference to FIGS. 7 to 9 and Table 3. FIG. 7 is a diagram showing a lens configuration of the zoom optical system according to the third example. The zoom optical system ZL(3) according to the third example comprises, in order from the object along the optical axis, the first lens group G1 having positive refractive power, the second lens group G2 having negative refractive power, the third lens group G3 having positive refractive power, the fourth lens group G4 having negative refractive power, the fifth lens group G5 having negative refractive power, the sixth lens group G6 having positive refractive power, the seventh lens group G7 having positive refractive power, the eighth lens group G8 having negative refractive power, and the ninth lens group G9 having negative refractive power. When zooming from the wide-angle end state (W) to the first telephoto end state (T), the second lens group G2, the third lens group G3, the fifth lens group G5, the sixth lens group G6, the seventh lens group G7, and the eighth lens group G8 move along the optical axis as indicated by the arrows in FIG. 7, and the distance between each adjacent lens group changes. Note that when zooming, the first lens group G1, the fourth lens group G4, and the ninth lens group G9 are fixed relative to the image surface I. The aperture stop S is arranged between the third lens group G3 and the fourth lens group G4, and the aperture stop S is fixed relative to the image surface I along with the fourth lens group G4 when zooming.

The first lens group G1 comprises, in order from the object along the optical axis, the cemented positive lens obtained by cementing together the meniscus-shaped negative lens L11 having a convex surface facing the object and the biconvex positive lens L12, and the meniscus-shaped positive lens L13 having a convex surface facing the object.

The second lens group G2 comprises, in order from the object along the optical axis, the meniscus-shaped negative lens L21 having a convex surface facing the object, the biconcave negative lens L22, the meniscus-shaped positive lens L23 having a convex surface facing the object, and the biconcave negative lens L24.

The third lens group G3 comprises, in order from the object along the optical axis, a biconvex positive lens L31 and the meniscus-shaped positive lens L32 having a convex surface facing the object.

The fourth lens group G4 comprises, in order from the object along the optical axis, a cemented negative lens obtained by cementing together the meniscus-shaped negative lens L41 having a convex surface facing the object and a meniscus-shaped positive lens L42 having a convex surface facing the object.

The fifth lens group G5 comprises, in order from the object along the optical axis, a biconcave negative lens L51, a meniscus-shaped negative lens L52 having a convex surface facing the object, and a meniscus-shaped positive lens L53 having a convex surface facing the object.

The sixth lens group G6 comprises, in order from the object along the optical axis, a biconvex positive lens L61, and a cemented positive lens obtained by cementing together a meniscus-shaped negative lens L62 having a convex surface facing the object and a biconvex positive lens L63.

The seventh lens group G7 comprises a meniscus-shaped positive lens L71 having a convex surface facing the object.

The eighth lens group G8 comprises, in order from the object along the optical axis, a meniscus-shaped negative lens L81 having a convex surface facing the object and the biconvex positive lens L82. An object-side lens surface of the meniscus-shaped negative lens L81 is an aspherical surface.

The ninth lens group G9 comprises, in order from the object along the optical axis, the meniscus-shaped negative lens L91 having a concave surface facing the object and the biconvex positive lens L92. An object-side lens surface of the meniscus-shaped negative lens L91 is an aspherical surface. The image surface I is arranged on the image side from the ninth lens group G9.

In the present example, the fourth lens group G4, the fifth lens group G5, the sixth lens group G6, the seventh lens group G7, the eighth lens group G8, and the ninth lens group G9 constitute the rear group GR. In the rear group GR, the fifth lens group G5 corresponds to the first focus lens group GF1, and the seventh lens group G7 corresponds to the second focus lens group GF2. The ninth lens group G9 corresponds to the final lens group GE. When focusing from the infinity object to the short-distance object in the wide-angle end state, the medium focal length state, and the telephoto end state, the first focus lens group GF1 (fifth lens group G5) and the second focus lens group GF2 (seventh lens group G7) move toward the object along the optical axis at different trajectories (movement amounts).

Data values of the zoom optical system according to the third example are listed in the following Table 3.

TABLE 3
[General Data]
Zooming ratio = 2.727

| | W | M | T |
|---|---|---|---|
| f | 71.500 | 135.000 | 195.000 |
| FNO | 2.880 | 2.880 | 2.880 |
| ω | 16.747 | 8.797 | 6.050 |
| Y | 21.700 | 21.700 | 21.700 |
| TL | 239.978 | 239.978 | 239.978 |
| Bf | 17.810 | 17.810 | 17.810 |

[Lens Data]

| Surface | | | | |
|---|---|---|---|---|
| Number | R | D | nd | νd |
| 1 | 109.659 | 2.800 | 1.92286 | 20.88 |
| 2 | 82.271 | 10.842 | 1.43700 | 95.10 |
| 3 | −330.813 | 0.100 | | |
| 4 | 78.131 | 7.122 | 1.49782 | 82.57 |
| 5 | 307.441 | (D5) | | |
| 6 | 51.751 | 2.000 | 1.83481 | 42.73 |
| 7 | 28.594 | 8.150 | | |
| 8 | −139.801 | 1.800 | 1.48749 | 70.32 |
| 9 | 65.177 | 0.100 | | |
| 10 | 43.822 | 4.076 | 1.92286 | 20.88 |
| 11 | 95.164 | 5.111 | | |
| 12 | −50.633 | 1.800 | 1.48749 | 70.32 |
| 13 | 317.698 | (D13) | | |
| 14 | 188.326 | 3.760 | 1.83481 | 42.73 |
| 15 | −250.346 | 0.100 | | |
| 16 | 47.444 | 5.947 | 1.49782 | 82.57 |
| 17 | 363.047 | (D17) | | |
| 18 | ∞ | 1.500 | (Aperture | |
| | | | Stop S) | |
| 19 | 48.849 | 1.853 | 2.00100 | 29.12 |
| 20 | 29.628 | 6.234 | 1.49782 | 82.57 |
| 21 | 124.040 | (D21) | | |
| 22 | −65.827 | 1.439 | 1.48749 | 70.32 |
| 23 | 70.507 | 1.322 | | |
| 24 | 447.716 | 1.418 | 1.83481 | 42.73 |
| 25 | 54.050 | 0.100 | | |
| 26 | 50.831 | 2.687 | 1.92286 | 20.88 |
| 27 | 87.988 | (D27) | | |
| 28 | 196.668 | 4.089 | 1.59319 | 67.90 |
| 29 | −74.796 | 0.100 | | |
| 30 | 87.236 | 1.550 | 2.00100 | 29.12 |
| 31 | 41.918 | 5.718 | 1.49782 | 82.57 |
| 32 | −134.651 | (D32) | | |
| 33 | 42.183 | 5.228 | 1.59319 | 67.90 |
| 34 | 267.553 | (D34) | | |
| 35* | 159.982 | 1.600 | 1.85108 | 40.12 |
| 36 | 34.158 | 3.067 | | |
| 37 | 164.439 | 3.840 | 1.80518 | 25.45 |
| 38 | −93.492 | (D38) | | |
| 39* | −24.902 | 1.551 | 1.85108 | 40.12 |
| 40 | −94.419 | 0.100 | | |
| 41 | 66.664 | 6.668 | 1.61293 | 36.95 |
| 42 | −101.262 | Bf | | |

[Aspherical Surface Data]
35th surface
κ = 1.000, A4 = 4.10175E−06, A6 = 1.87631E−10,
A8 = 1.07919E−12, A10 = 0.00000E+00
39th surface
κ = 1.000, A4 = 1.01290E−06, A6 = −7.68488E−09,
A8 = 3.60877E−11, A10 = −8.29554E−14

[Variable Distance Data]
Upon focusing on infinity

| | W | M | T |
|---|---|---|---|
| Focal length | 71.500 | 135.000 | 195.000 |
| D0 | ∞ | ∞ | ∞ |
| D5 | 1.500 | 23.225 | 38.559 |
| D13 | 49.481 | 24.746 | 1.500 |
| D17 | 2.008 | 5.018 | 12.929 |
| D21 | 12.289 | 17.413 | 3.733 |
| D27 | 9.729 | 6.501 | 17.742 |
| D32 | 12.904 | 11.199 | 16.523 |
| D34 | 18.149 | 18.464 | 13.189 |
| D38 | 12.336 | 11.828 | 14.222 |
| Bf | 17.810 | 17.810 | 17.810 |

Upon focusing on a short-distance object

| | W | M | T |
|---|---|---|---|
| Zoom | −0.199 | −0.130 | −0.165 |
| magnification | | | |
| D0 | 250.000 | 700.000 | 900.000 |
| D5 | 1.500 | 23.225 | 38.559 |
| D13 | 49.481 | 24.746 | 1.500 |
| D17 | 2.008 | 5.018 | 12.929 |
| D21 | 8.548 | 7.647 | 3.319 |
| D27 | 13.470 | 16.268 | 18.156 |
| D32 | 5.534 | 1.883 | 1.473 |
| D34 | 25.519 | 27.780 | 28.240 |
| D38 | 12.336 | 11.828 | 14.222 |
| Bf | 17.810 | 17.810 | 17.810 |

[Lens Group Data]

| Group | First surface | Focal length |
|---|---|---|
| G1 | 1 | 117.117 |
| G2 | 6 | −39.745 |
| G3 | 14 | 59.286 |
| G4 | 19 | −23380.000 |
| G5 | 22 | −48.470 |
| G6 | 28 | 71.329 |
| G7 | 33 | 83.699 |
| G8 | 35 | −201.391 |
| G9 | 39 | −113.675 |

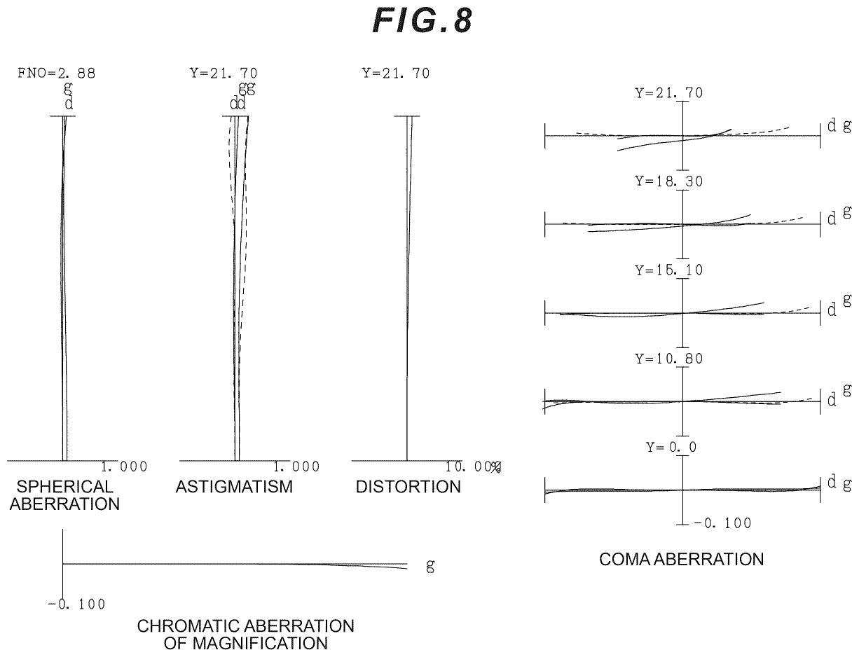

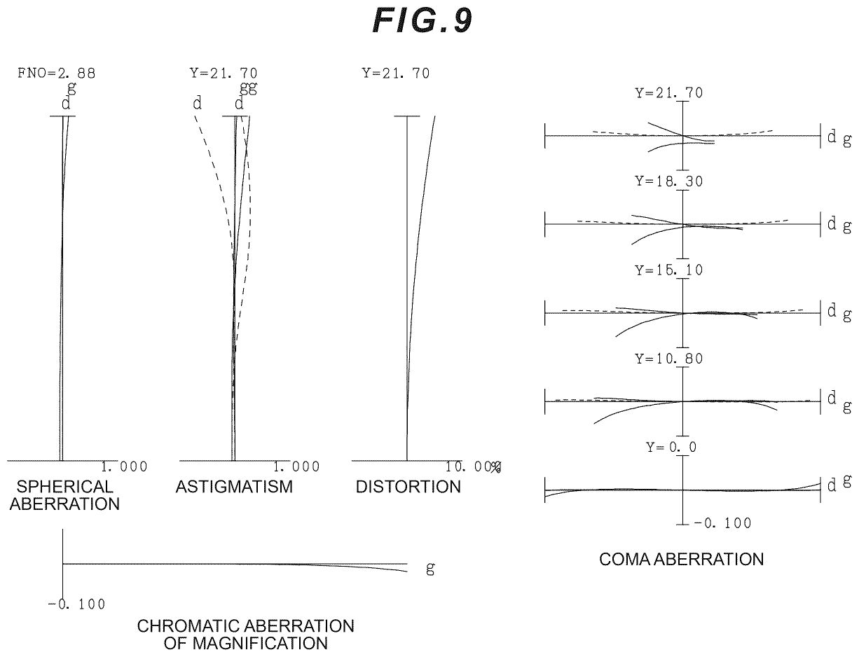

FIG. 8 illustrates graphs showing various aberrations upon focusing on infinity in the wide-angle end state of the zoom optical system according to the third example. FIG. 9 illustrates graphs showing various aberrations upon focusing on infinity in the telephoto end state of the zoom optical system according to the third example. As is apparent from the graphs showing various aberrations, the zoom optical system according to third example can favorably correct various aberrations from the wide-angle end state to the telephoto end state, and has superior image formation performance.

Next, a “Conditional Expression Corresponding Value” table is shown below. This table summarizes values corresponding to the conditional expressions (1) to (12) for all of the examples (first to third examples).

0.05<(−f2)/f1<1.00 Conditional expression (1)

0.02<Bft/ft<0.15 Conditional expression (2)

0.10<(−fF1)/fF2<1.30 Conditional expression (3)

0.01<Bfw/fw<0.50 Conditional expression (4)

0.50<f2/fF1<1.00 Conditional expression (5)

1.20<f1/fF2<2.00 Conditional expression (6)

0.50<f3/fF2<1.00 Conditional expression (7)

2.00<TLw/fw<6.00 Conditional expression (8)

0.01<(−f2)/f3<2.00 Conditional expression (9)

1.80<f1/f3<2.50 Conditional Expression (10)

0.01<|fr1/fr|<5.00 Conditional expression (11)

0.10<f2/fr1<0.75 Conditional expression (12)

[Conditional Expression Corresponding Value]
(first to third example)

| Conditional | First | Second | Third |
|---|---|---|---|
| Expression | example | example | example |
| (1) | 0.348 | 0.319 | 0.339 |
| (2) | 0.059 | 0.089 | 0.091 |
| (3) | 0.674 | 0.735 | 0.579 |
| (4) | 0.164 | 0.249 | 0.249 |
| (5) | 0.885 | 0.777 | 0.820 |
| (6) | 1.712 | 1.789 | 1.399 |
| (7) | 0.757 | 0.881 | 0.708 |
| (8) | 3.495 | 3.495 | 3.356 |
| (9) | 0.787 | 0.649 | 0.670 |
| (10) | 2.261 | 2.031 | 1.975 |
| (11) | 0.084 | 0.774 | 1.772 |
| (12) | 0.639 | 0.371 | 0.197 |

According to each of the above examples, it is possible to realize a zoom optical system having bright and favorable optical performance while being compact.

Each of the above examples is a specific example of the present invention, and the present invention is not limited thereto.

The contents described below can be adopted properly without impairing the optical performance of the zoom optical system of each embodiment.

An 8-group configuration and a 9-group configuration are shown as examples of the zoom optical system of each embodiment, but the present application is not limited thereto, and the zoom optical system can also have another group configurations (for example, 10-group, 11-group, 12-group, or the like). For example, a configuration may be used in which a lens or a lens group is added to the zoom optical system of each embodiment closest to the object or the image surface. Also, for example, a configuration may be used in which a lens or a lens group is added to the rear group in the zoom optical system of each embodiment closest to the object or the image surface. Note that lens group indicates a portion including at least one lens separated by an air distance that changes upon zooming.

The zoom optical system of each embodiment is not limited to including the first to third focus lens groups described above, a single or a plurality of lens groups, or a partial lens groups may serve as a focus lens group that is moved in the optical axis direction and perform focusing from the infinity object to the short-distance object. The focus lens group can also be applied to autofocus, and is also suited to autofocus motor driving (using an ultrasonic motor or the like).

A lens group or a partial lens group may serve as a vibration-proof lens group that is moved so as to have a movement component in a direction perpendicular to the optical axis or moved rotationally (swung) in a direction in a plane including the optical axis to reduce image blur caused by camera shake.

Each lens surface may be formed as a spherical surface, a planar surface, or an aspherical surface. The lens surface is preferably a spherical surface or a planar surface, because this facilitates lens processing and assembly adjustment, and deterioration in optical performance due to errors in the processing and the assembly adjustment can be prevented. This is also preferable, because there is only little deterioration in depiction performance even when the image surface is displaced.

When the lens surface is aspherical, the aspherical surface may be any of an aspherical surface obtained by grinding, a molded glass aspherical surface obtained by forming glass into an aspherical shape using a mold, or a composite type aspherical surface obtained by forming a resin into an aspherical shape on the surface of glass. The lens surface may also be a diffractive surface, and the lens may also be a gradient index lens (GRIN lens) or a plastic lens.

The aperture stop is preferably arranged between the third lens group and the fourth lens group, but a lens frame may be adapted to serve as an aperture stop without providing an actual member of an aperture stop.

In order to achieve high-contrast optical performance with reduced flaring and ghosting, an anti-reflective coating having high transmittance over a wide wavelength range may also be applied to each lens surface.

### EXPLANATION OF NUMERALS AND CHARACTERS

G1: first lens group
G2: second lens group
G3: third lens group
G4: fourth lens group
G5: fifth lens group
G6: sixth lens group
G7: seventh lens group
G8: eighth lens group
G9: ninth lens group
I: image surface
S: aperture stop

1. A zoom optical system comprising:
in order from an object along an optical axis, a first lens group having positive refractive power, a second lens group having negative refractive power, a third lens group having positive refractive power, and a rear group including at least five lens groups, wherein
when zooming, a distance between each adjacent lens group changes, and the first lens group is fixed relative to an image surface, and
the following conditional expressions are satisfied:
0.05<(−f2)/f1<1.00
0.02<Bft/ft<0.15
Where f1: a focal length of the first lens group,
f2: a focal length of the second lens group,
ft: a focal length of the zoom optical system in a telephoto end state, and
Bft: a back focus of the zoom optical system in the telephoto end state.

2. The zoom optical system according to claim 1, wherein the following conditional expression is satisfied:
0.01<Bfw/fw<0.50
Where fw: a focal length of the zoom optical system in a wide-angle end state, and
Bfw: a back focus of the zoom optical system in the wide-angle end state.

3. The zoom optical system according to claim 1, wherein
the at least five lens groups of the rear group include a first focus lens group having negative refractive power, and a second focus lens group having positive refractive power and being arranged closer to the image surface than the first focus lens group,
when focusing, the first focus lens group and the second focus lens group move along the optical axis at different trajectories, and
the following conditional expression is satisfied:
0.10<(−fF1)/fF2<1.30
Where fF1: a focal length of the first focus lens group, and
fF2: a focal length of the second focus lens group.

4. A zoom optical system comprising:
in order from an object along an optical axis, a first lens group having positive refractive power, a second lens group having negative refractive power, a third lens group having positive refractive power, and a rear group including at least five lens groups, wherein
when zooming, a distance between each adjacent lens group changes, and the first lens group is fixed relative to an image surface, and
the at least five lens groups of the rear group include a first focus lens group having negative refractive power, and a second focus lens group having positive refractive power and being arranged closer to the image surface than the first focus lens group,
when focusing, the first focus lens group and the second focus lens group move along the optical axis at different trajectories, and
the following conditional expressions are satisfied-:
0.10<(−fF1)/fF2<1.30
0.01<Bfw/fw<0.50
Where fF1: a focal length of the first focus lens group,
fF2: a focal length of the second focus lens group,
fw: a focal length of the zoom optical system in a wide-angle end state, and
Bfw: a back focus of the zoom optical system in the wide-angle end state.

5. The zoom optical system according to claim 3, wherein the following conditional expression is satisfied:
0.50<f2/fF1<1.00
Where f2: the focal length of the second lens group.

6. The zoom optical system according to claim 3, wherein the following conditional expression is satisfied:
1.20<f1/fF2<2.00
Where f1: the focal length of the first lens group.

7. The zoom optical system according to claim 3, wherein the following conditional expression is satisfied:
0.50<f3/fF2<1.00
Where f3: a focal length of the third lens group.

8. The zoom optical system according to claim 3, wherein the second focus lens group comprises one lens component.

9. The zoom optical system according to claim 1, wherein the following conditional expression is satisfied:
2.00<TLw/fw<6.00
Where fw: the focal length of the zoom optical system in the wide-angle end state, and
TLw: an entire length of the zoom optical system in the wide-angle end state.

10. The zoom optical system according to claim 1, wherein the following conditional expression is satisfied:
0.01<(−f2)/f3<2.00
Where f2: the focal length of the second lens group, and
f3: the focal length of the third lens group.

11. The zoom optical system according to claim 1, wherein the following conditional expression is satisfied:
1.80<f1/f3<2.50
Where f1: the focal length of the first lens group, and
f3: the focal length of the third lens group.

12. The zoom optical system according to claim 1, wherein
the at least five lens groups of the rear group include a final lens group arranged closest to the image surface, and
the following conditional expression is satisfied:
0.01<|fr1/fr|<5.00
Where fr: a focal length of the final lens group, and
fr1: a focal length of the final lens group in the rear group.

13. The zoom optical system according to claim 1, wherein
the at least five lens groups of the rear group include the final lens group arranged closest to the image surface, and
the following conditional expression is satisfied:
0.10<f2/fr1<0.75
Where f2: the focal length of the second lens group, and
fr1: a focal length of the final lens group in the rear group.

14. The zoom optical system according to claim 1, wherein
the at least five lens groups of the rear group include the final lens group arranged closest to the image surface, and
when zooming, the final lens group is fixed relative to the image surface.

15. The zoom optical system according to claim 1, wherein
the at least five lens groups of the rear group include the final lens group arranged closest to the image surface, and
the final lens group comprises, in order from the object along the optical axis, a negative lens and a positive lens.

16. An optical device comprising the zoom optical system according to claim 1.

17. A method of manufacturing a zoom optical system comprising, in order from an object along an optical axis, a first lens group having positive refractive power, a second lens group having negative refractive power, a third lens group having positive refractive power, and a rear group including at least five lens groups, wherein
when zooming, a distance between each adjacent lens group changes, and the first lens group is fixed relative to an image surface, and
the method of manufacturing the zoom optical system comprises the following feature A or B, wherein
the feature A comprises:
arranging each lens in a lens barrel so that the following conditional expressions are satisfied:
0.05<(−f2)/f1<1.00
0.02<Bft/ft<0.15
Where f1: a focal length of the first lens group,
f2: a focal length of the second lens group,
ft: a focal length of the zoom optical system in a telephoto end state, and
Bft: a back focus of the zoom optical system in the telephoto end state, and
the feature B comprises:
the at least five lens groups of the rear group include a first focus lens group having negative refractive power, and a second focus lens group having positive refractive power and being arranged closer to the image surface than the first focus lens group,
when focusing, the first focus lens group and the second focus lens group move along the optical axis at different trajectories, and
arranging each lens in a lens barrel so that the following conditional expressions are satisfied:
0.10<(−fF1)/fF2<1.30
0.01<Bfw/fw<0.50
Where fF1: a focal length of the first focus lens group,
fF2: a focal length of the second focus lens group,
fw: a focal length of the zoom optical system in a wide-angle end state, and
Bfw: a back focus of the zoom optical system in the wide-angle end state.

18. (canceled)

19. The zoom optical system according to claim 4, wherein the following conditional expression is satisfied:
0.50<f2/fF1<1.00
Where f2: the focal length of the second lens group.

20. The zoom optical system according to claim 4, wherein the following conditional expression is satisfied:
1.20<f1/fF2<2.00
Where f1: the focal length of the first lens group.

21. The zoom optical system according to claim 4, wherein the following conditional expression is satisfied:
0.50<f3/fF2<1.00
Where f3: a focal length of the third lens group.

22. The zoom optical system according to claim 4, wherein the second focus lens group comprises one lens component.

23. The zoom optical system according to claim 4, wherein the following conditional expression is satisfied:
2.00<TLw/fw<6.00
Where fw: the focal length of the zoom optical system in the wide-angle end state, and
TLW: an entire length of the zoom optical system in the wide-angle end state.

24. The zoom optical system according to claim 4, wherein the following conditional expression is satisfied:
0.01<(−f2)/f3<2.00
Where f2: the focal length of the second lens group, and
f3: the focal length of the third lens group.

25. The zoom optical system according to claim 4, wherein the following conditional expression is satisfied:
1.80<f1/f3<2.50
Where f1: the focal length of the first lens group, and
f3: the focal length of the third lens group.

26. The zoom optical system according to claim 4, wherein
the at least five lens groups of the rear group include a final lens group arranged closest to the image surface, and
the following conditional expression is satisfied:
0.01<|fr1/fr|<5.00
Where fr: a focal length of the final lens group, and
fr1: a focal length of the final lens group in the rear group.

27. The zoom optical system according to claim 4, wherein
the at least five lens groups of the rear group include the final lens group arranged closest to the image surface, and
the following conditional expression is satisfied:
0.10<f2/fr1<0.75
Where f2: the focal length of the second lens group, and
fr1: a focal length of the final lens group in the rear group.

28. The zoom optical system according to claim 4, wherein
the at least five lens groups of the rear group include the final lens group arranged closest to the image surface, and
when zooming, the final lens group is fixed relative to the image surface.

29. The zoom optical system according to claim 4, wherein
the at least five lens groups of the rear group include the final lens group arranged closest to the image surface, and
the final lens group comprises, in order from the object along the optical axis, a negative lens and a positive lens.

30. An optical device comprising the zoom optical system according to claim 4.
